(19) United States
(12) Patent Application Publication
(10) Pub. No.: US 2010/0175503 A1
(43) Pub. Date: Jul. 15, 2010

(54) Wave Generator for Wave Gear Device

(75) Inventors: Xin Yue Zhang, Azumino-shi (JP); Toshimi Yamagishi, Azumino-shi (JP); Keiji Ueura, Azumino-shi (JP)

Correspondence Address: BUCHANAN, INGERSOLL & ROONEY PC, POST OFFICE BOX 1404, ALEXANDRIA, VA, 22313-1404, US

(73) Assignee: HARMONIC DRIVE SYSTEMS INC., Shinagawa-ku (JP)

(21) Appl. No.: 12/652,217

(22) Filed: Jan. 5, 2010

(30) Foreign Application Priority Data
Jan. 13, 2009 (JP) 2009-004452

(51) Int. Cl. F16H 49/00; F16H 1/00

(52) U.S. Cl. 74/640

(57) ABSTRACT

The flexible bearing of the wave generator for a wave gear device is a deep-groove ball bearing in which an outer race and an inner race form an annular flexible bearing ring capable of bending in a radial direction. A ball diameter Da is set to be 5 to 15% greater than that of each model of the currently available product, and dimensions of orbital plane radii ro, ri of the inner and outer races are set so that the ratio ro/Da of the orbital plane radius ro of the inner race and the ball diameter Da, as well as the ratio ri/Da of the orbital plane radius ri of the outer race and the ball diameter Da, are both 0.8 to 2% less than those ratios in each model of the currently available product. When the ball diameter and the orbital plane radii are thus set, it is possible to substantially extend the service life of the flexible bearing.

### TECHNICAL FIELD

The present invention relates to a wave generator for a wave gear device, and more particularly relates to a technique for attaining a long service life in a flexible bearing, which is an essential part of the wave generator, in order to extend the service life of the wave gear device.

### BACKGROUND ART

A wave gear device comprises a rigid internally toothed gear, a flexible externally toothed gear disposed on the inside of the internally toothed gear, and a wave generator that bends the flexible externally toothed gear into an elliptical shape and causes the externally toothed gear to partially mesh with the rigid internally toothed gear. When the wave generator is rotated by a motor or the like, the positions where the two toothed gears are enmeshed with each other move in a circumferential direction, and relative rotation whose speed is reduced in accordance with the difference in the number of teeth between the toothed gears is generated between the two toothed gears. One of the gears is nonrotatably fixed to allow reduced-speed rotation to be output and transmitted to the load from the other toothed gear.

The wave generator comprises a rigid plug attached to a motor axle or the like, and a flexible bearing mounted on an elliptical external circumferential surface of the rigid plug. The flexible bearing has the same structure as a typical radial ball bearing, but the inner and outer races of the flexible bearing form a flexible bearing ring capable of bending in a radial direction. The flexible bearing is mounted between the elliptical external circumferential surface of the rigid plug and an internal circumferential surface of the flexible externally toothed gear. The flexible bearing holds the rigid plug and the flexible externally toothed gear in a state in which the plug and the gear can rotate relative to each other.

Wave gear devices can be divided into three types: flat type, cup type, and “silk hat” type, according to the shape of the flexible externally toothed gear. These types of wave gear device are disclosed in Patent Documents 1, 2, and 3.

[Patent Document 1] JP-A 05-172195

[Patent Document 2] JP-A 08-166052

[Patent Document 3] JP-U 02-91238

### DISCLOSURE OF THE INVENTION

### Problems the Invention is Intended to Solve

Wave gear devices have few components, highly precise rotary transmission, and a high reduction ratio; therefore, they are incorporated and used in drive mechanisms for robot arms and the like. In recent years, there has been a growing demand for higher-performance, higher-speed robots, and this has been accompanied by a growing demand for a higher performance, and particularly for an extended service life, in wave gear devices. In order to extend the service life of wave gear devices, it is essential to extend the service life of the flexible bearing in a wave generator in which the flexible externally toothed gear is rotationally moved while being bent.

However, up until the present time, no consideration has been given to extending the service life of flexible bearings in which the inner and outer races are rotated while being bent in the radial direction. Specifically, it bas been a few decades since the wave gear device has come into practical use, but the components constituting the flexible bearing have merely been used unmodified all this time without any changes being made to their dimensions.

An object of the present invention is to improve the flexible bearing that rotates while bending in a radial direction in a wave gear device, and to extend the service life of the bearing.

### Means for Solving the Problems

In order to solve the abovementioned problems, the present invention provides a wave generator for a wave gear device wherein a flexible externally toothed gear disposed inside an annular rigid internally toothed gear is bent into a non-circular shape and caused to partially mesh with the rigid internally toothed gear to move the meshing positions of the two toothed gears in a circumferential direction and to generate relative rotation between the two toothed gears brought about by a difference in the number of teeth of the two toothed gears, the wave generator characterized in comprising:

a rigid plug; and

an annular flexible bearing bent into a non-circular shape by a non-circular external circumferential surface of the rigid plug;

wherein the flexible bearing is a deep-groove ball bearing having an annular flexible outer race and flexible inner race capable of bending in a radial direction;

wherein the ball diameter Da of the flexible bearing is set to dimensions 5 to 15% greater in relation to the dimensions of each model of the currently available product; and

wherein dimensions of orbital plane radii ro, ri of the inner and outer races are set so that the ratio ro/Da of the orbital plane radius ro of the inner race and the ball diameter Da, as well as the ratio ri/Da of the orbital plane radius ri of the outer race and the ball diameter Da, are both 0.8 to 2% less than those ratios in each model of the currently available product.

It is preferable that the ball diameter Da be set to dimensions 11% greater than the dimensions of each model of the currently available product, and

dimensions of orbital plane radii ro, ri of the inner and outer races be set so that the ratios ro/Da and ri/Da are each 1.2% less than those ratios in each model of the currently available product.

As a general rule, the rigid plug comprises an elliptical external circumferential surface, and the flexible bearing and the flexible externally toothed gear are bent into an elliptical shape.

### Effect of the Invention

The present inventors conducted a study into changes in the rated life of each model and each type of the currently available wave gear device by changing the ball diameter and conformity (ro/Da, ri/Da) of the flexible bearing of the wave generator. As a result, it was determined that making the ball diameter 5 to 15% greater relative to the dimensions of each model of the currently available product, as well as setting the dimensions of the orbital plane radii ro, ri of the inner and outer races so that the conformity is 0.8 to 2% less, makes it possible to increase the rated life by a factor of 5 or greater.

In particular, it was determined that when the ball diameter is approximately 11% greater than the dimensions of each model of the currently available product, and the orbital plane radii are set so that the conformity is approximately 1.2% less, the rated life can be increased by at least a factor of 6 or greater.

Therefore, according to the present invention, it is possible to extend the service life of the flexible bearing in a wave generator, and therefore to substantially extend the service life of the wave gear device in comparison with the conventional art.

### BRIEF DESCRIPTION OF THE DRAWINGS

FIG. 1 is a view depicting a cup-type wave gear device to which the present invention can be applied;

FIG. 2 is a partial cross-sectional view of a flexible bearing of the wave gear device of FIG. 1;

FIG. 3 is a graph showing endurance test results for the flexible bearing according to the present invention; and

FIG. 4 is a graph showing endurance test results for the flexible bearing according to the present invention.

### BEST MODE FOR CARRYING OUT THE INVENTION

Described below with reference to the accompanying drawings is a long-lasting, flexible bearing of a wave generator in a wave gear device to which the present invention is applied.

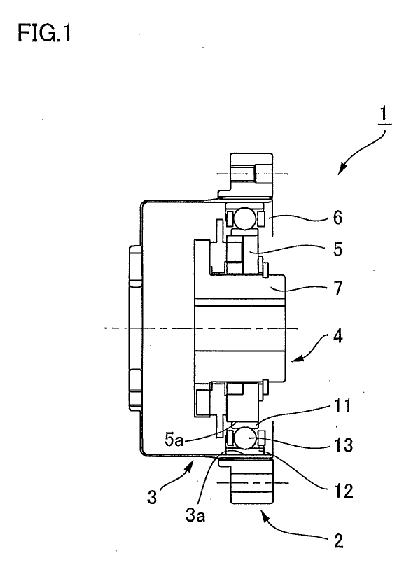

FIG. 1 is an illustrative diagram showing one example of a wave gear device to which the present invention can be applied. The wave gear device 1 shown in the drawing is a cup-type device comprising a rigid internally toothed gear 2, a cup-shaped flexible externally toothed gear 3 disposed on the inside of the internally toothed gear 2, and a wave generator 4 that bends the flexible externally toothed gear 3 into an elliptical shape and causes the externally toothed gear 3 to partially mesh with the rigid internally toothed gear 2. The difference in the number of teeth between the toothed gears 2, 3 is 2n (where n is a positive integer). As a general rule, the difference is 2 and the rigid internally toothed gear 2 has the greater number of teeth.

When the wave generator 4 is rotated at high speed by a motor or the like (not shown), the positions where the toothed gears 2, 3 are enmeshed with each other move in a circumferential direction, generating a decrease in the speed of relative rotation between the toothed gears 2, 3 that corresponds to the difference in the number of teeth between the toothed gears 2, 3. It is possible to make one of the gears a fixed gear that does not rotate, thereby causing the other gear to output rotation at a reduced speed and transmit the rotation to the load side.

The wave generator 4 comprises a rigid plug 5 and a flexible bearing 6 mounted on an elliptical external circumferential surface 5a of the rigid plug 5. The rigid plug 5 is attached to a hub 7 so as to integrally rotate therewith. The hub 7 is fixedly connected to a motor axle or the like. The flexible bearing 6 has the same structure as a typical deep-groove ball bearing, but the inner race 11 and outer race 12 of the flexible bearing form a flexible bearing ring capable of bending in a radial direction, and balls 13 can roll and move along a track formed between the races. The flexible bearing 6 is mounted between the elliptical external circumferential surface 5a of the rigid plug 5 and the internal circumferential surface 3a of a portion of the flexible externally toothed gear 3 on which the external teeth are formed. The flexible bearing 6 holds the rigid plug 5 and the flexible externally toothed gear 3 while allowing the plug and the gear to rotate relative to each other.

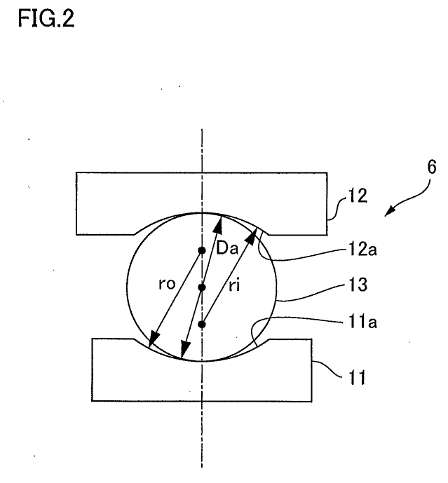

FIG. 2 is a partial cross-sectional view of the flexible bearing 6. As shown in the drawing, the basic structure of the flexible bearing 6 is the same as a typical deep-groove ball bearing; however, ball diameter and conformity (the ratio between the radii of the orbital planes of the inner and outer races and the ball diameter) is different from the dimensions of currently available products.

The ball diameter Da of the balls 13 fitted into the flexible bearing 6 is set to a dimension that is 11% greater than the ball diameters of each model of the currently available product, as shown in FIG. 2, where the ball diameter is Da, the orbital plane radius of the orbital plane 11a of the inner race 11 is ro, and the radius of the orbital plane 12a of the outer race 12 is ri. The dimensions of the orbital plane radii ro, ri of the inner and outer races 11, 12 are set so that the conformity on the side of the inner race 11 (the ratio ro/Da of the orbital plane radius ro of the inner race and the ball diameter Da) and the conformity on the side of the outer race 12 (the ratio ri/Da of the orbital plane radius ri of the outer race and the ball diameter Da) are both 1.2% less than those ratios in each model of the currently available product.

The ball diameters in each model of the currently available product are as follows, and the minimum value of conformity is 51%, the maximum value is 53%, and the average value is 52%.

Model Ball diameter (mm)

| | |
|---|---|
| 8 | 2.000 |
| 11 | 2.381 |
| 14 | 3.175 |
| 17 | 4.000 |
| 20 | 4.763 |
| 25 | 5.556 |
| 32 | 7.144 |
| 40 | 9.525 |
| 45 | 11.000 |
| 50 | 11.906 |
| 58 | 13.494 |
| 65 | 14.288 |
| 80 | 19.050 |
| 90 | 21.431 |
| 100 | 23.813 |

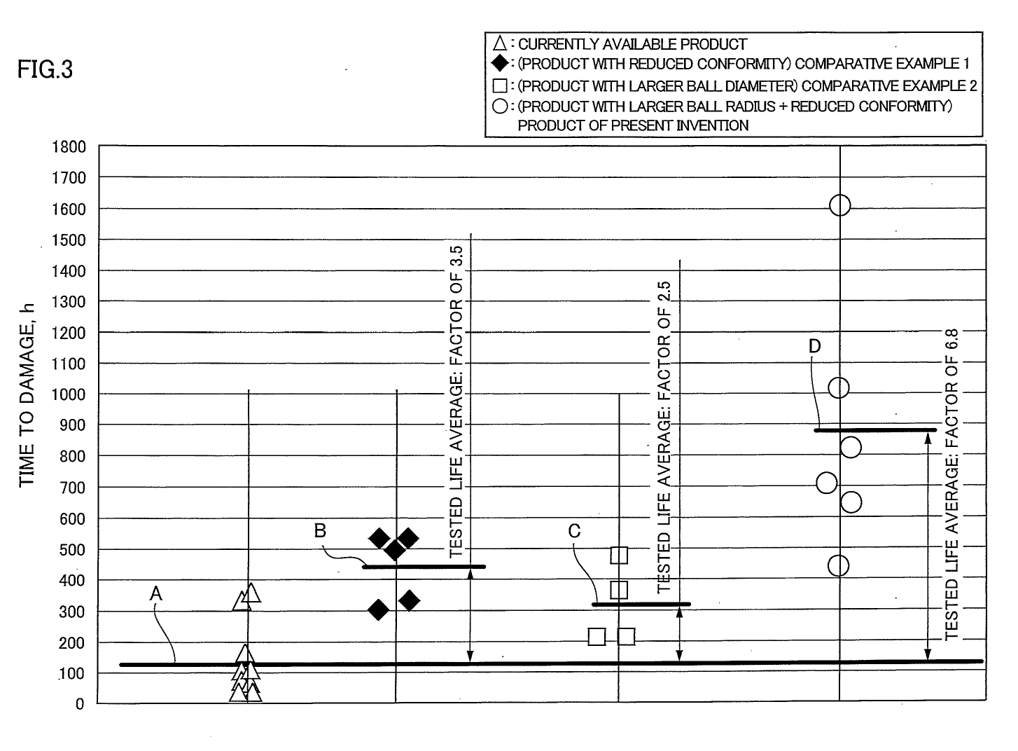

FIG. 3 is a graph showing one example of results of a test conducted by the present inventors on the fatigue life of the flexible bearing. The fatigue life test measured the amount of time for damage to occur when the currently available product, comparative example 1, comparative example 2, and the product of the present invention were operated under identical conditions. Relative to the conformity and the ball diameter of the flexible bearing in the currently available product, the radii of the orbital planes of the inner and outer races were set so that only the conformity was 1.2% less in comparative example 1, only the ball diameter was 11% greater in comparative example 2 than in the currently available product, and the conformity was 1.2% less and the ball diameter was 11% greater in the product of the present invention. The other conditions were identical, and the materials used were also identical.

In the graph, horizontal line A is the average life of the currently available product, horizontal line B is the average life of comparative example 1, horizontal line C is the average life of the comparative example 2, and horizontal line D is the average life of the product of the present invention. The average life increased by factors of 3.5 and of 2.5 in comparative examples 1, 2, respectively, and the average life increased by a factor of 6.8 in the product of the present invention. Therefore, it is clear that the present invention makes it possible to substantially lengthen the life of the flexible bearing 6.

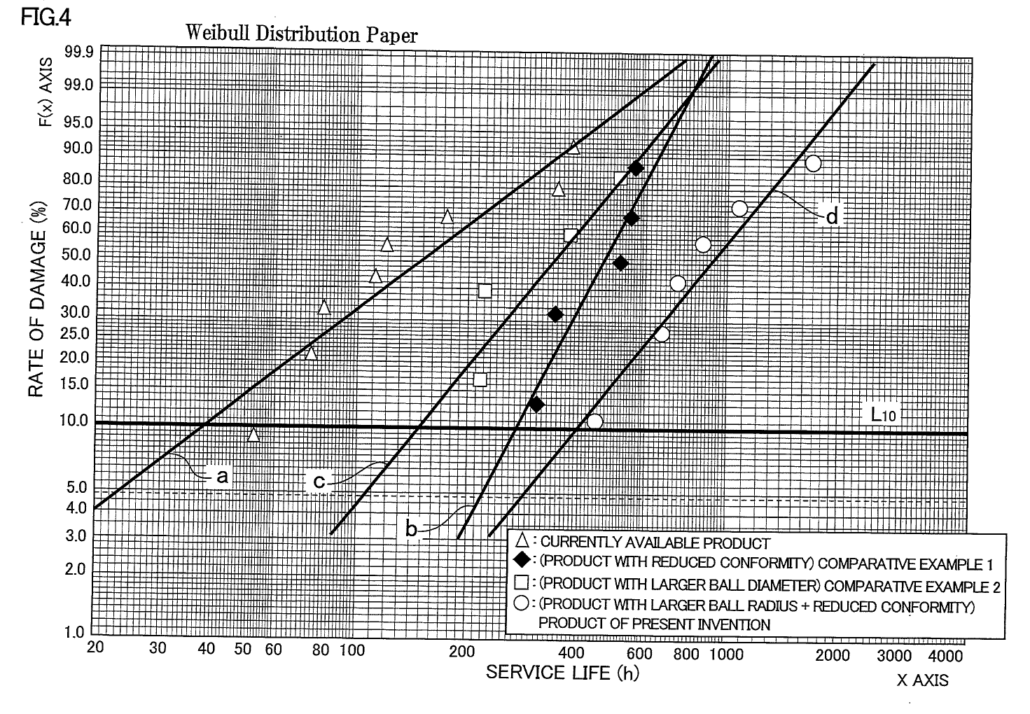

FIG. 4 is a graph displaying the results of fatigue life tests on the above four types of flexible bearings, wherein the vertical axis is used as the coordinate axis for the rate of damage (%), and the horizontal axis is used as the coordinate axis for the service life (hours). The straight lines a to d are approximation lines showing the rate of damage in relation to the desired operation time for the currently available product, comparative example 1, comparative example 2, and the product of the present invention, respectively. The rated life L₁₀ of the product of the present invention is substantially improved relative to that of the currently available product, comparative example 1, and comparative example 2. Moreover, the relative increase of the rate of damage in relation to the operation time is lower than for comparative examples 1, 2.

The experiments conducted by the present inventors confirmed that the service life of a flexible bearing can be extended by a factor of 5 or greater over that of the currently available product by making the ball diameter 5 to 15% greater and the conformity 0.82% less.

1. A wave generator for a wave gear device wherein a flexible externally toothed gear disposed inside an annular rigid internally toothed gear is bent into a non-circular shape and caused to partially mesh with the rigid internally toothed gear to move the meshing positions of the two toothed gears in a circumferential direction and to generate relative rotation between the toothed gears brought about by a difference in the number of teeth of the two toothed gears, the wave generator comprising:
a rigid plug; and
an annular flexible bearing bent into a non-circular shape by a non-circular external circumferential surface of the rigid plug;
wherein the flexible bearing is a deep-groove ball bearing having an annular flexible outer race and flexible inner race capable of bending in a radial direction;
wherein the ball diameter Da of the flexible bearing is set to dimensions 5 to 15% greater in relation to the dimensions of each model of the currently available product; and
wherein dimensions of orbital plane radii ro, ri of the inner and outer races are set so that the ratio ro/Da of the orbital plane radius ro of the flexible inner race and the ball diameter Da, as well as the ratio ri/Da of the orbital plane radius ri of the flexible outer race and the ball diameter Da, are both 0.8 to 2% less than those ratios in each model of the currently available product.

2. A wave generator for a wave gear device, wherein
the ball diameter Da is set to dimensions 11% greater than the dimensions of each model of the currently available product; and
dimensions of orbital plane radii ro, ri of inner and outer races are set so that the ratios ro/Da and ri/Da are each 1.2% less than those ratios in each model of the currently available product.

3. The wave generator for a wave gear device according to claim 1, wherein
the rigid plug comprises an elliptical external circumferential surface (5a); and
the flexible bearing and the flexible externally toothed gear are bent into an elliptical shape.

4. The wave generator for a wave gear device according to claim 2, wherein
the rigid plug comprises an elliptical external circumferential surface; and
the flexible bearing and the flexible externally toothed gear are bent into an elliptical shape.
